(19) United States
(12) Patent Application Publication
(10) Pub. No.: US 2014/0034625 A1
(43) Pub. Date: Feb. 6, 2014

(54) METHOD AND SYSTEM OF ELIMINATING POST-WELD BUILD UP

(71) Applicant: LINCOLN GLOBAL, INC., City of Industry, CA (US)

(72) Inventor: Joseph A. DANIEL, Sagamore Hill, OH (US)

(73) Assignee: LINCOLN GLOBAL, INC., City of Industry, CA (US)

(21) Appl. No.: 13/802,865

(22) Filed: Mar. 14, 2013

Related U.S. Application Data
(60) Provisional application No. 61/679,481, filed on Aug. 3, 2012.

(51) Int. Cl. B23K 26/38

(52) U.S. Cl. CPC B23K 26/38
USPC 219/121.72; 219/121.67

(57) ABSTRACT

A system and method is provided to use a laser system to remove excess weld bead build up from a workpiece after a welding operation. After a weld bead is formed a weld bead can have a protrusion which extends above a surface of a workpiece and it is desirable to remove the protrusion. A system and method is provided which uses a laser beam oriented at an angle and delivered with an intensity sufficient eliminate or remove the excess weld bead build up.

### PRIORITY

The present application claims priority to U.S. Provisional Patent Application No. 61/679,481 filed Aug. 3, 2012, which is incorporated herein by reference in its entirety.

### TECHNICAL FIELD

This invention relates to systems and methods for post-weld processing. More specifically, the subject invention relates to methods and systems for eliminating post-weld build up (face or root enforcement) using a laser.

### BACKGROUND

Carrying out a welding operation results in a weld bead that generally projects above the workpiece surface, i.e., post-weld material (face or root reinforcement). Exemplary welding operations include electric arc welding, laser welding and hot wire welding. Shown in FIG. 1 is an exemplary typical weld bead 10 which joins a first workpiece 12 and a second workpiece 14. The weld bead 10 extends linearly (along the Y-Y axis) and further spans and fills the groove between the workpieces 12, 14 (along the X-X axis). Completion of the welding process provides for an excess weld material 10a having a thickness t which extends above the surface of the workpieces 12, 14. The excess material 10a may be removed using know material removal tools such as for example, grinders. There is a need for alternative systems and methods to remove the post-weld material.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention provide for system and methods for post-weld removal of excess weld material for joined workpieces. In one aspect, the system includes a laser delivery assembly to deliver a laser beam at a weld-to-laser distance sufficient to melt or vaporize the excess material. One embodiment of the system includes a laser absorption element to absorb laser energy as it removes the excess weld material. Alternatively or in addition to, a fume extraction device is mounted to collect the fumes produced from the removal process. The subject removal process in one aspect provides for relative movement between the joined workpieces and the laser beam. In one aspect, the joined workpieces remains stationary and the laser beam is moved with respect to the workpieces. In alternative embodiments, the workpieces are moved relative to the laser beam.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is an illustrative embodiment of a typical weld bead with excess weld material;

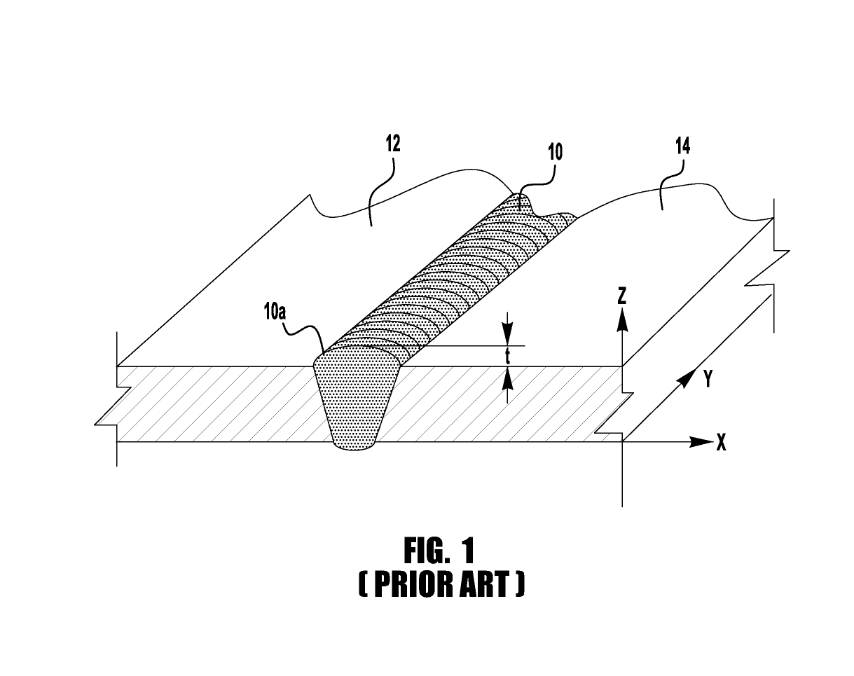

FIG. 2A is an illustrative embodiment of a system for removing the excess weld material of FIG. 1;

FIG. 2B is a plan view of an alternate arrangement of the system of FIG. 2A;

FIG. 2C is a cross-sectional view of an alternate embodiment of the system of FIG. 2A;

FIG. 2D is a cross-sectional view of an alternate embodiment of the system of FIG. 2A.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

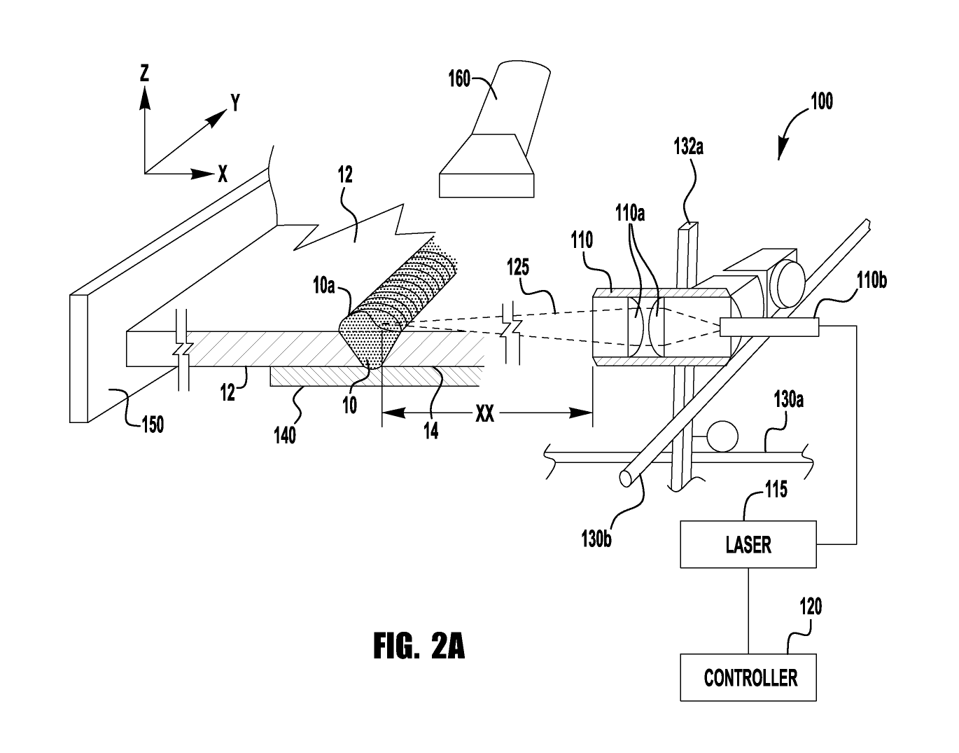

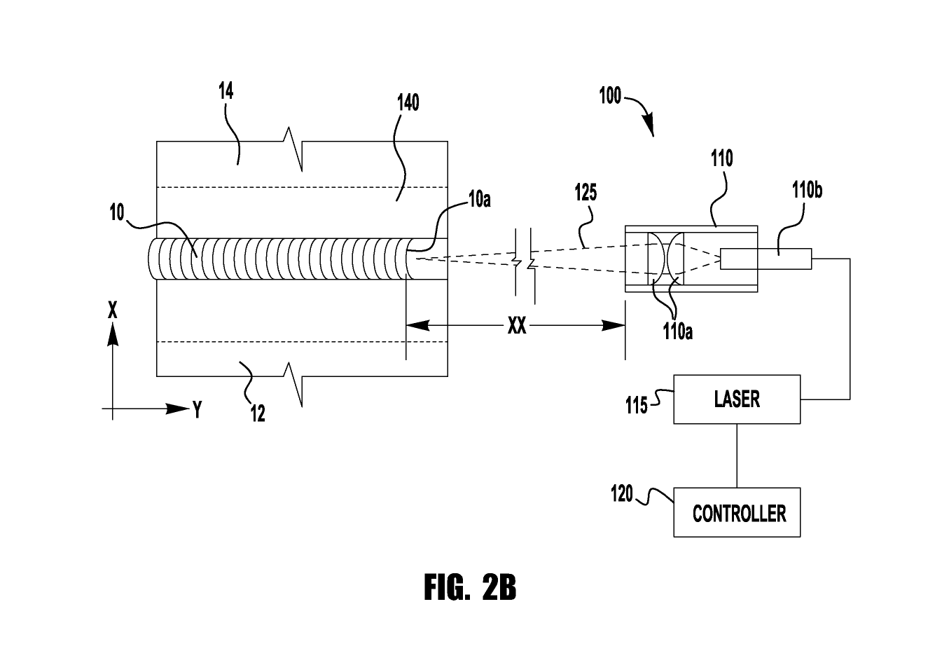

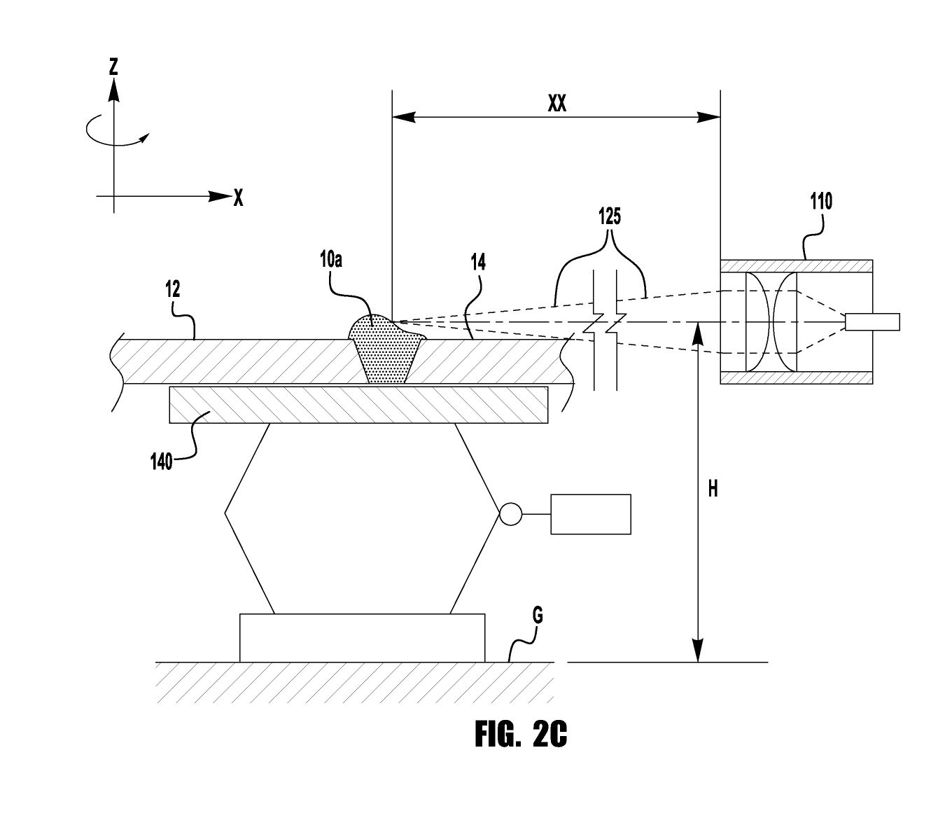

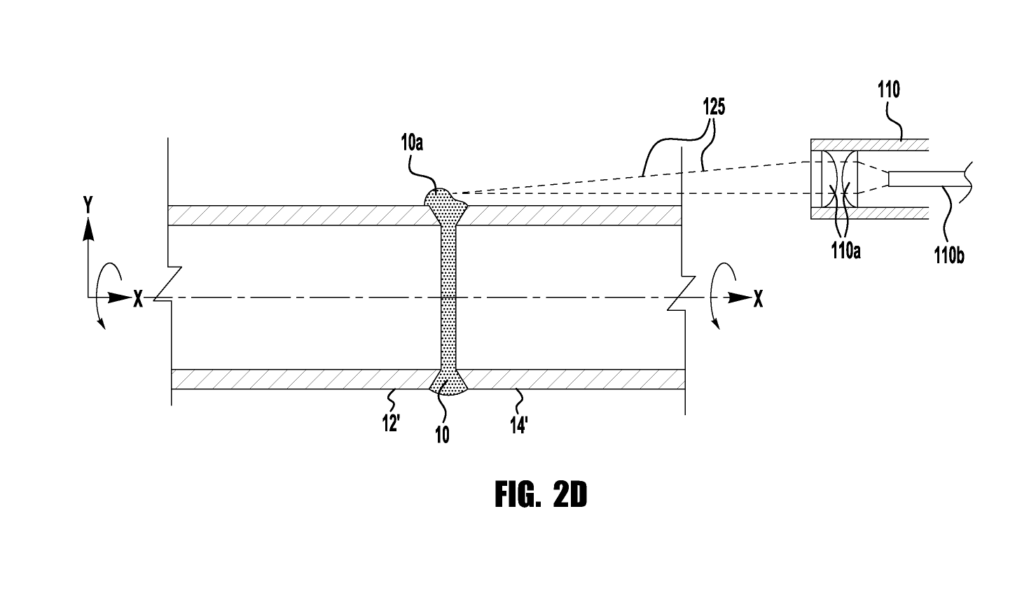

Shown in FIG. 2A is a system 100 for removing the excess weld bead material 10a. Generally, the system 100 includes a laser delivery assembly 110 coupled to a laser source 115. The laser delivery assembly 110 may be configured for fiber delivery so as to include appropriate laser optics 110a coupled to a fiber delivery 110b for delivery of a laser beam 125 from the laser source 115. To control the intensity of the laser beam 125, a controller 120 is coupled to the laser source 115. In one aspect, the laser optics 110a are configured as a collimating and focusing laser optic assembly 110a to define a laser beam 125 sufficient to melt an amount of weld material and more particularly, weld metal. Other configurations of the laser optics 110a are possible to carry out the post-weld removal process.

The laser optics assembly 110 in one embodiment is a substantially cylindrical member has a distal end from which a collimated and focused laser beam exits and a proximal end coupled to the laser beam delivery device 110b. Exemplary embodiments of the laser source 115 includes CO2, Nd:YAG; Fiber or Direct Diode for providing a wavelength from about 1 micron to about 11 microns and more particularly 0.8 microns to about 10.6 microns. In one exemplary embodiment, the laser source 115 provides a power density of about 500 W/cm². In some embodiments, the laser optics subassembly 110a includes two lenses: a collimating lens and a focus lens which are spaced apart to form a laser beam 125 having a particular wavelength and energy at the weld joint. Of course, other optics configurations can be used.

The system 100 is configured such that the laser beam 125 and joined workpieces 12, 14 can be moved relative to one another for removal of the excess weld bead material 10a which extends or projects above the surfaces of the workpieces. In one aspect, the joined workpieces 12, 14 can be mounted and affixed during the post-weld removal process. Accordingly, the laser subassembly 110 is moved about the workpiece so as to scan the laser beam 125 over the weld bead 10 to remove the excess material 10a. In one embodiment, the laser assembly 110 is configured to translate linearly along at least three axes: axis X-X horizontally transverse to the weld bead 10; axis Y-Y parallel to bead 10; and axis Z-Z vertically transverse to the weld bead 10. In one exemplary embodiment, the optics assembly 110a is mounted for controlled translation along a first rail 130a extending parallel to axis X-X and a second rail 130b extending parallel to the Y-Y axis and perpendicular to the first rail 130a. To translate the laser subassembly 110 vertically, the optic assembly 110a can be, for example, mounted to a rack 132a by a pinion (not shown) for vertical translation along the Z-Z axis. Alternative arrangements for locating and translating the optics of a laser assembly are shown and described in U.S. Patent Publication No. 2011/0297658, which is attached incorporated herein by reference in its entirety.

In an exemplary operation, the joined workpieces 12, 14 are affixed to, for example, a stationary material handling table 140. The laser beam 125 is delivered and located at the weld 10 to melt and remove the excess material 10a. To properly locate the laser beam 125 along the weld 10, the laser optics assembly 110 is translated in a controlled manner over the rails 130a, 130b and/or rack and pinion 132a by, for example, appropriate motorized gearing, exemplary motorized gearing is shown and described in U.S. Pat. No. 5,227,601, which is incorporated fully herein by reference.

To remove the excess weld material 10a, laser beam 125 is of sufficient intensity to melt, in some embodiments, or vaporize—in other embodiments—the excess weld material 10a. More particularly, the laser beam 125 is controlled by the controller 120 to deliver an intensity of laser energy at a laser-to-weld distance XX sufficient to melt and/or vaporize the excess material 10a. In one aspect, the excess weld material 10a is removed such that the resultant weld bead 10 is substantially flush with the surfaces of the workpieces 12, 14. With reference to FIG. 2A, the joined workpieces 12, 14 are arranged with respect to the laser subassembly 110 such that the laser beam 125 extends transverse to the weld bead 10 to define a substantially constant laser-to-weld distance. With reference to FIG. 2B, the joined workpieces 12, 14 are alternatively arranged with respect to the laser subassembly 110 such that the laser beam 125 extends collinear to the weld bead 10 so that the laser-to-weld distance varies as the excess weld material 10a is removed.

Referring again to FIG. 2A, the system 100 may further include a laser absorption member 150 opposed the laser optics assembly 110a to absorb the laser beam energy while the laser is being located at the weld 10 or to absorb the energy when the removal process is completed. In addition, the system 100 may include a fume extraction assembly 160 for removal of fume materials produced from the melting and/or evaporating weld metal.

In alternate system arrangements, the laser subassembly 110a remains stationary and the workpiece is moved to locate the weld bead 10 and excess material 10a in the path of the laser beam 125. For example, as shown in FIG. 2C, the laser subassembly 110 operates in fixed position to deliver the laser beam 125. The laser beam 125 remains fixed with respect to a stationary reference point such as for example, the ground G at a distance H. To locate the weld bead 10 and its excess material in the path of the laser beam 125, the joined workpieces 12, 14 mounted to a movable/rotatable work table 140. Other alternate arrangements include where the workpieces, such as for example, a joint pipe assembly 12′, 14′ is rotated about axis X-X, as seen in FIG. 2D.

In further exemplary embodiments, rather than removing the excess material 10a from the weld 10, embodiments of the present invention melt the excess material 10a so that is distributed flatter over the surface of the workpieces 12 and 14. That is, after the welding process the laser 110 and beam 125 reheat the material 10a to allow the excess material to spread out over the surface of the workpieces, thus lowering the overall height of the bead 10.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed.

What is claimed is:

1. A system for eliminating excess material of a weld bead from a workpiece, the system comprising:
a laser delivery system coupled to a laser source, which delivers a laser beam to a weld bead on a workpiece after a welding operation;
a translation system for relative translation between the workpiece and the laser delivery system; and
a controller coupled to the laser source for delivery of the laser beam with an intensity at a weld-to-laser distance between the weld bead and the laser delivery system sufficient to eliminate excess material from the weld bead,
wherein the laser deliver system delivers the laser beam at an angle such that the excess material of the weld bead protruding above a surface of said workpiece can be removed by the laser beam.

2. The system of claim 1, wherein the translation system translates the workpiece relative to the laser delivery system, the laser delivery system being stationary.

3. The system of claim 1, wherein the translation system translates the laser delivery system relative to the workpiece, the workpiece being stationary.

4. The system of claim 1, further comprising an absorption member disposed about the weld bead opposite the laser delivery system to absorb at least some of the laser beam.

5. The system of claim 1, wherein the laser delivery system is oriented with respect to the weld bead so as to define a constant weld-to-laser distance.

6. The system of claim 1, wherein the laser delivery system is oriented to deliver the laser beam axially aligned with the weld bead to define a variable weld-to-laser distance, the controller configured to vary the intensity of the laser beam.

7. A method for eliminating excess material of a weld bead from a workpiece, the system comprising:
welding a workpiece to create a weld bead, where said weld bead has a portion which protrudes above a surface of said workpiece;
directing a laser beam from a laser beam assembly to said weld bead on said workpiece;
translating the laser beam relative to said workpiece and said weld bead; and
controlling the intensity of the laser beam at a weld-to-laser distance between the weld bead and the laser delivery system sufficient to eliminate excess material from the weld bead,
wherein said laser beam is directed at an angle such that the excess material of the weld bead protruding above the surface of said workpiece is removed by the laser beam.

8. The method of claim 8, wherein during translation the laser beam assembly is stationary.

9. The method of claim 8, wherein during translation the workpiece is stationary.

10. The system of claim 8, further comprising positioning an absorption member opposite the laser delivery system to absorb at least some of the laser beam.

11. The method of claim 8, further comprising maintaining a constant weld-to-laser distance between said laser beam assembly and said weld bead.

12. The method of claim 8, further comprising varying a weld-to-laser distance between said laser beam assembly and said weld bead.
